(19) United States
(12) Patent Application Publication
(10) Pub. No.: US 2007/0014958 A1
(43) Pub. Date: Jan. 18, 2007

(54) Hanger labels, label assemblies and methods for forming the same

(76) Inventors: Ernest R. Chaplin, Hopedale, MA (US); Carl W. Treleaven, Madeira Beach, FL (US)

Correspondence Address: MYERS BIGEL SIBLEY & SAJOVEC, PO BOX 37428, RALEIGH, NC, 27627, US

(21) Appl. No.: 11/477,584

(22) Filed: Jun. 29, 2006

Related U.S. Application Data
(60) Provisional application No. 60/697,621, filed on Jul. 8, 2005.

(51) Int. Cl. B32B 33/00

(52) U.S. Cl. 428/40.1

(57) ABSTRACT

A label assembly includes a release liner and a label. The label includes a base layer releasably adhered to the release liner. The base layer includes at least one label cut line formed therein defining a hanger and an adjacent anchoring portion. A release liner piece is defined by at least one release liner cut line formed in the release liner. The release liner piece is adhered to the anchoring portion and underlies the hanger such that the release liner piece remains with the base layer and supports the hanger when the base layer is dispensed from the release liner. According to some embodiments, the base layer is a single-ply base layer.

### RELATED APPLICATION(s)

The present application claims the benefit of and priority from U.S. Provisional Patent Application Ser. No. 60/697,621, filed Jul. 8, 2005, the disclosure of which is incorporated herein by reference in its entirety.

### FIELD OF THE INVENTION

The present invention relates to devices for suspending articles, and more particularly, to labels including hangers and securable to articles.

### BACKGROUND OF THE INVENTION

It is often necessary or desirable to hang various articles from supports for storage and convenient access. For example, IV bottles and bags often must be suspended from stands for gravitational feed of the contents of the bottles or bags. Similarly, consumers often wish to hang bottles of shampoo, soap, bath oils and the like in their showers or elsewhere. Various other packaged articles are often suspended from retail display supports. A number of hanging devices for such purposes have been proposed, including self-adhesive labels including integral hangers. See, for example, U.S. Pat. No. 5,135,125 to Andel et al. Additionally, some hanger devices are mechanically secured to an article, such as in the container and retractable hanger system disclosed in U.S. Pat. No. 5,749,497 to Davis.

### SUMMARY OF THE INVENTION

According to embodiments of the present invention, a label assembly includes a release liner and a label. The label includes a base layer releasably adhered to the release liner. The base layer includes at least one label cut line formed therein defining a hanger and an adjacent anchoring portion. A release liner piece is defined by at least one release liner cut line formed in the release liner. The release liner piece is adhered to the anchoring portion and underlies the hanger such that the release liner piece remains with the base layer and supports the hanger when the base layer is dispensed from the release liner. According to some embodiments, the base layer is a single-ply base layer.

According to embodiments of the present invention, a label for use with an article includes a base layer, a base adhesive layer, and a release liner piece. The base layer includes at least one label cut line formed therein defining a hanger and an adjacent anchoring portion. The base adhesive layer coats a rear surface of the base layer. The release liner piece is adhered to the anchoring portion by the base adhesive layer and underlies the hanger such that the release liner piece remains with the base layer and supports the hanger when the base layer is dispensed onto the article.

According to further embodiments of the present invention, a label for use with an article includes a base layer, a base adhesive layer, and a supplemental piece. The base layer includes at least one label cut line formed therein defining a hanger and an adjacent anchoring portion. The base adhesive layer coats a rear surface of the base layer. The supplemental piece is adhered to the anchoring portion by the base adhesive layer and overlies the hanger such that the supplemental piece retains the hanger with respect the anchor portion when the base layer is dispensed onto the article.

According to method embodiments of the present invention, a method for forming a label assembly includes: providing a release liner; releasably adhering a base layer to the release liner; forming at least one label cut line in the base layer to define a hanger and an adjacent anchoring portion in the base layer; and forming at least one release liner cut line in the release liner to define a release liner piece therein such that the release liner piece is adhered to the anchoring portion and underlies the hanger such that the release liner piece remains with the base layer and supports the hanger when the base layer is dispensed from the release liner.

According to method embodiments of the present invention, a method for dispensing a label onto an article includes providing a label assembly including a release liner and a label. The label includes a base layer releasably adhered to the release liner. The base layer includes at least one label cut line formed therein defining a hanger and an adjacent anchoring portion. A release liner piece is defined by at least one release liner cut line formed in the release liner. The release liner piece is adhered to the anchoring portion and underlies the hanger such that the release liner piece remains with the base layer and supports the hanger when the base layer is dispensed from the release liner. The method further includes dispensing the label from the release liner onto the article such that the release liner piece remains adhered to the anchoring portion and underlying the hanger to thereby support the hanger during the transition from the release liner to the article.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a top plan view of a label assembly according to embodiments of the present invention;

FIG. 2 is a cross-sectional view of the label assembly of FIG. 1 taken along the line 2-2 of FIG. 1;

FIG. 3 is a bottom plan view of the label assembly of FIG. 1;

FIG. 4A is a perspective view of a label of the label assembly of FIG. 1 mounted on an article with a hanger of the label in a stored position;

FIG. 4B is a perspective view of the label mounted on the article of FIG. 4B with the hanger in a deployed position;

FIG. 5 is a top plan view of the label of FIG. 4A being dispensed onto the article from a release liner of the label assembly of FIG. 1;

FIG. 6 is a perspective view of the label of the label assembly of FIG. 1 partially removed from the release liner of the label assembly;

FIG. 7 is a diagram of an apparatus for forming the label assembly of FIG. 1;

FIG. 8 is a top plan view of a label assembly according to further embodiments of the present invention;

FIG. 9 is a top plan view of a label assembly according to further embodiments of the present invention; and

FIG. 10 is a cross-sectional view of the label assembly of FIG. 9 taken along the line 10-10 of FIG. 9.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In accordance with embodiments of the present invention, hanger labels and assemblies including the same are provided. The labels are adapted to be adhesively secured to an article for suspending the article. The labels and label assemblies may provide for more efficient and consistent or reliable dispensation of the labels from a release liner onto articles. According to some embodiments, the label includes a single-ply base layer within which the hanger is formed. According to some embodiments, the label is a self-adhesive label. Further aspects of the present invention and embodiments thereof will be appreciated from the description that follows.

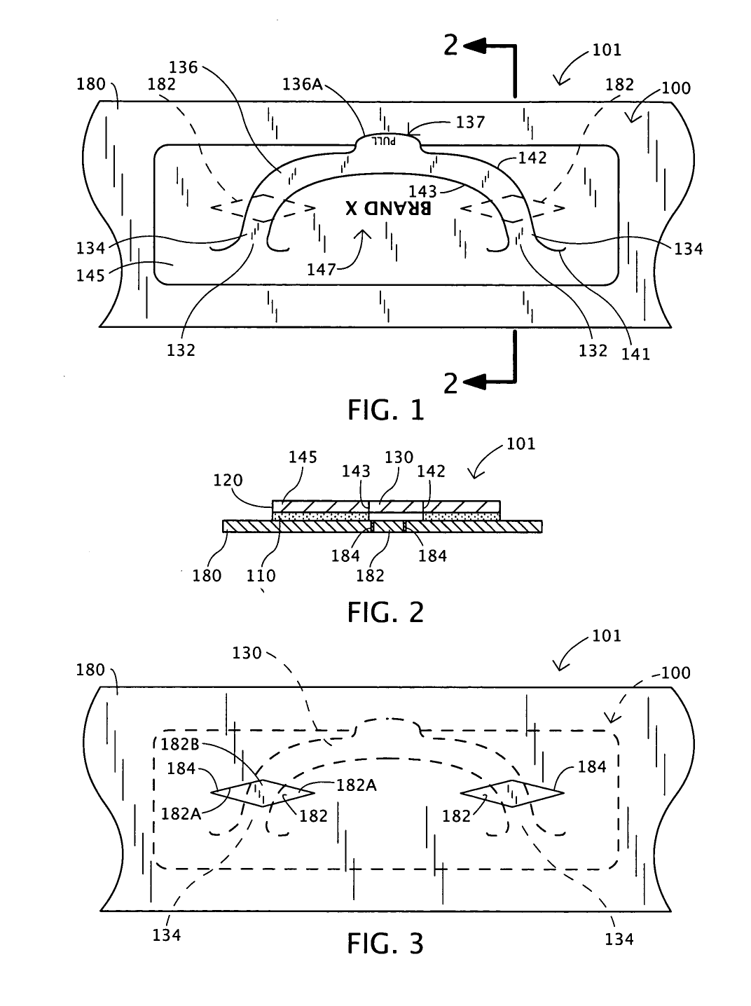

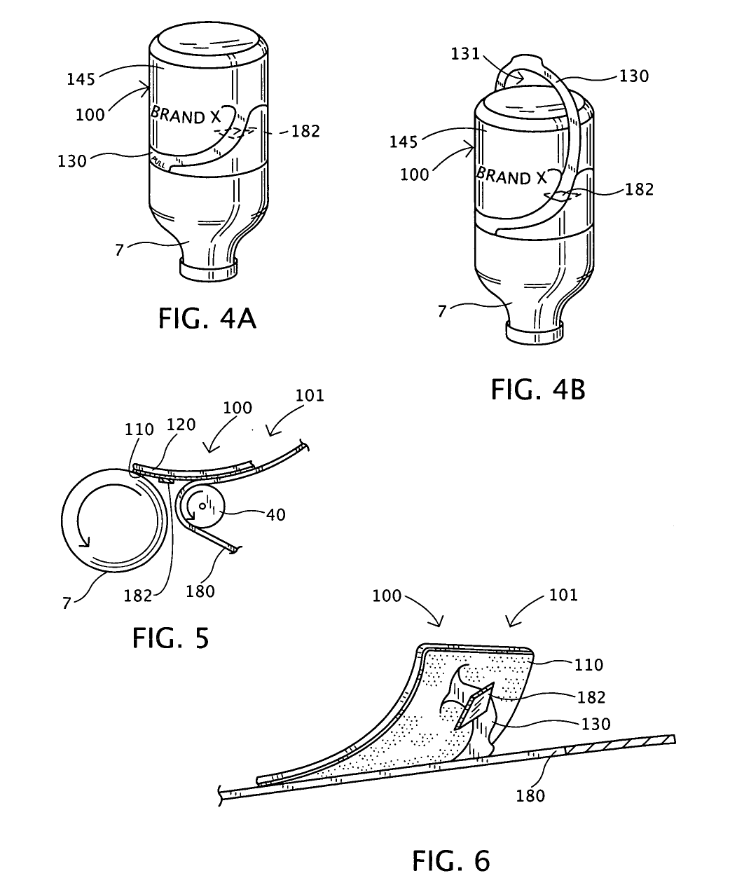

With reference to FIGS. 1-7, a label assembly 101 according to embodiments of the present invention is shown therein. The label assembly 101 includes a label 100 mounted on a release liner 180. The label 100 includes a base layer 120 with a pressure sensitive adhesive 110 on the rear surface thereof. The base layer 120 includes generally an anchoring portion 145 and a hanger 130. The base layer 120 is formed of a continuous, unitary layer of material with diecuts 142 and 143 formed therein defining the hanger 130. The label 100 may serve to suspend an article 7 (see FIG. 4B).

Turning to the label 100 in more detail, the hanger 130 includes legs 134 extending from opposed ends 132 and connected to one another by a connecting portion 136. A pull tab 136A extends from the connecting portion 136. In this manner, the hanger 130 forms a continuous, closed loop from one end 132 to the other end 132. The ends 132 are integral with the anchoring portion 145. The anchoring portion 145 includes all of the parts of the base layer 120 other than the hanger 130. Diecut stress relief curves 141 are formed at the ends 132.

Indicia 137 instructing a user to “pull” is printed on the pull tab 136A. Indicia 147 such as product identification and/or other information is printed on the anchoring portion 145.

The base layer 120 is formed of a flexible material, for example, a flexible polymeric film. Suitable materials for the base layer 120 include White TR-303 film available from Polymeric Converting of Enfield, Connecticut.

The adhesive 110 coats only a portion of the lower surface of the base layer 120. In particular, the adhesive 110 coats only the lower surface of the anchoring portion 145 and not the hanger 130. Accordingly, the base layer 120 may be pivoted away from the remainder of the label 100 about the ends 132. The adhesive 110 may be a pressure sensitive adhesive. The adhesive may also be a heat activatable adhesive. Suitable adhesives include a permanent acrylic adhesive such as GPMA040 adhesive available from Polymeric Converting of Enfield, Connecticut.

The release liner 180 may be of any suitable type and construction. Suitable release liners may include, for example, a glassine liner such as a 53 pound glassine liner, such as that available from Polymeric Converting of Enfield, Connecticut.

Cut lines 184 such as die cuts extend through the release liner 180 to define a pair of release liner pieces 182. Each release liner piece 182 includes an intermediate portion 182B underlapping a leg 134 of the hanger 130. Each release liner piece 182 further includes a pair of extension or side portions 182A extending laterally from either side of the intermediate portion 182B and underlapping the anchoring portion 145 on either side of the respective leg 134. The side portions 182A are adhered to the layer 120 by the adhesive 110. According to some embodiments, the intermediate portion 182B is not coated or engaged with adhesive and is not directly adhered to the hanger 130.

For illustrative purposes, the article 7 (FIGS. 4A and 4B) is a cylindrical container. The label assembly 101 and the label 100 may be used with articles of other types and may be oriented differently with respect to the article, depending on the application.

In use, the label 100 may be removed from the release liner 180 and applied to the article 7. The label 100 may be applied manually, using semi-automatic labeling equipment or using automatic labeling equipment, for example. The anchoring portion 145 is permanently adhered to the article 7 by the adhesive 110.

With reference to FIGS. 5 and 6, the label assembly 101 and the label 100 may be particularly beneficial when applied using semi-automatic labeling equipment or using automatic labeling equipment. As illustrated in FIG. 6, when the label 100 is peeled away from the release liner 180, the release liner pieces 182 will limit, and according to some embodiments prevent, the hanger 130 from flopping apart from the anchor portions 145, or vice-versa. In particular, the release liner pieces 182 may hold the hanger 130 in place during dispensing of the label 100 from the release liner 180 to the article 7. The pieces 182 serve as bridges and/or supports between the regions of the anchoring portions 145 on either side of the respective leg 134.

Referring to FIG. 5, the label assembly 101 is shown therein with the label 100 being applied to the article 7 from the release liner 180. A leading end of the label 100 is directed onto the article 7 and the article 7 is rotated such that the label is wrapped about and adhered to the article 7 (shown partly wrapped in FIG. 5 and fully wrapped in FIG. 4A) as the release liner 180 is drawn away about a pull roller 40. As the label 100 is peeled away from the release liner 180, the pieces 182 (one shown in FIG. 5) are peeled away from release liner 180 with the layer 120. The release liner pieces 182 thus serve to hold the hanger 130 in place during the transition from the release liner 180 to the mounting surface of the article 7. Accordingly, the label 100 can be more efficiently and consistently applied to the article even though the hanger is not mounted on or folded onto a self-adhesive base label or layer. Hanger labels such as the label 100 may be more cost-effectively manufactured than labels incorporating such a base label or folds.

The article 7 may be suspended, for example, from a rod of a display rack, using the label 100. Once the label is secured to the article 7, the hanger 130 may remain in the stored position as shown in FIG. 4A until the user desires to suspend the article 7. The shape of the article 7 (e.g., cylindrical) may serve to retain the hanger 130 in its stored position until deliberately deployed by a user. The user may pull the hanger 130 up by the pull tab 136A about the ends 132. The hanger 130 is thereby lifted away from remainder of the label 100 and the article 7 into an extended or hanging position as shown in FIG. 4B so that an opening 131 is defined therein to receive a support. As discussed above, the label 100 may be configured such that the intermediate portions 182B are not directly adhered to the hanger 130, thereby permitting the hanger 130 to be lifted away without resistance.

As an alternative (not shown), rather than being free of adhesive, the underside of the hanger 130 may be coated with the adhesive 110 and an adhesive deadener so that a deadened adhesive is presented on the underside. Suitable adhesive deadeners include M800 adhesive deadener from Radcure, Inc. of Fairfield, N.J. and FT33HG adhesive deadener from Northwest Coatings of Oak Creek, Wis. The deadened adhesive does not adhere or only nominally adheres to the article 7 so that the label may be used in the same manner as described above.

As a further alternative (not shown), the adhesive deadener may be replaced with a permanently adhered or releasable coherent layer such as a web of face stock or a release liner. This layer is preferably only applied over the adhesive present on the hanger and serves to prevent exposure of this adhesive.

As a further alternative (not shown), the adhesive coating the underside of the hanger 130 may be an adhesive of the type commonly referred to as a “fugitive adhesive”. Such adhesives are characterized in that they are operative to adhere two layers (in this case, the hanger 130 and the article 7) but, when the two layers are separated, the exposed hanger adhesive is substantially non-adherent. When the adhesive dries, the bond will remain strong enough to hold the layers together until the bond is broken by deliberately separating the layers. The adhesive is then dry and tackless (i.e., at least nontacky to the touch) and will not adhere to anything or unduly collect dirt and debris. Preferably, the materials of the hanger 130 and the article 7 and the hanger adhesive are chosen such that the hanger adhesive will remain with the underside of the hanger 130. The particular characteristics of the adhesive will depend on the materials to be bonded as well as the required performance parameters (e.g., the desired amount of force required to break the bond between the articles). Suitable adhesives include WB4738 available from H. B. Fuller of St. Paul, Minn. Preferably, the hanger adhesive is substantially transparent. An alternative suitable adhesive is described in U.S. Pat. No. 4,479,838 to Dunsim et al., the disclosure of which is incorporated herein by reference.

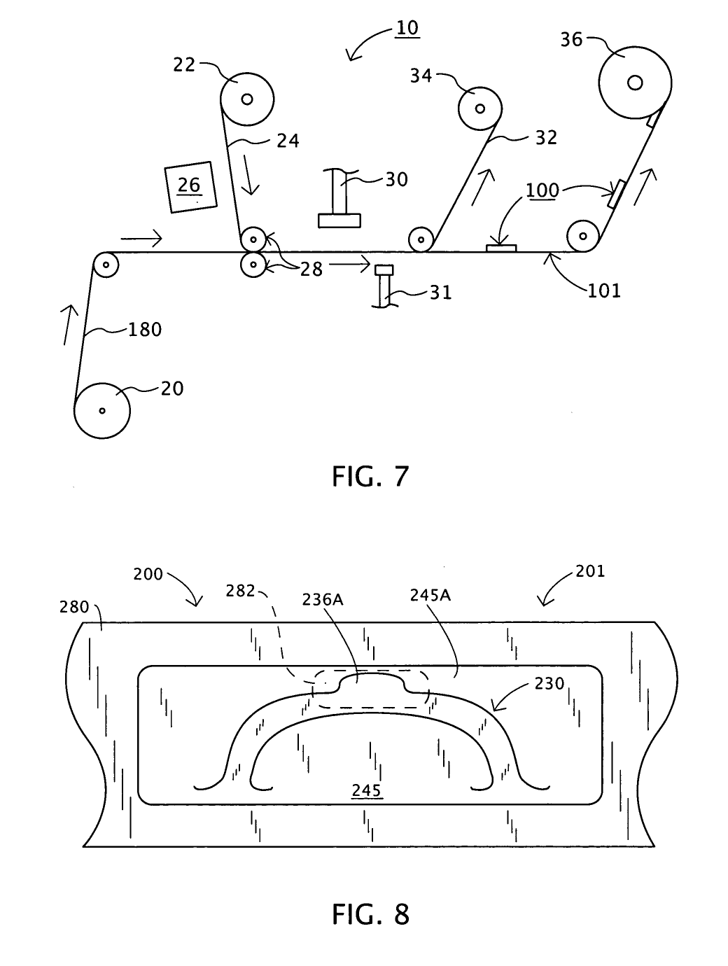

With reference to FIG. 7, an apparatus 10 for making the label assembly 101 is shown therein. The release liner 180 is unwound from an unwinding station 20. A non-adhesive web 24 of material corresponding to the base layer 120 is unwound from an unwinding station 22. An adhesive print station 26 prints the adhesive 110 in the appropriate pattern on the underside of the web 24 or onto the top side of the release liner 180. The adhesive coated surface of the web 24 is married to the release liner 180 by nip rollers 28. A diecut station 30 forms the diecuts 142, 143 of the label 100 as well as the periphery of the label 100. A diecut station 31 forms the diecuts 184 through and from the back side of the release liner 180 to form the release liner pieces 182 of each label 100. A waste matrix 32 including the portion of the web 24 outside of the label 100 is taken away by a winding station 34. The labels 100 are then wound onto a roll at a winding station 36.

The method and apparatus as described above may be used to make the label having a hanger coated with deadened adhesive with suitable modifications. In particular, the web 24 is replaced with a self-adhesive web (which may be provided as a release liner backed face stock, whereupon the release liner would first be removed) and the adhesive print station 26 is replaced with an adhesive deadener printing station which prints the appropriate pattern of adhesive deadener. For example, a composite web including a release liner, an adhesive, and a film laminate as described above may be provided, the laminate separated from the release liner, a deadener printed on the hanger regions of the adhesive, and the release liner thereafter remarried to the laminate. Suitable composite webs may include a pre-formed web of White TR-303 film laminate, GPMA040 permanent acrylic adhesive, and a 53 pound glassine release liner as available from Polymeric Converting of Enfield, Conn.

Release liner pieces corresponding to the release liner pieces 182 may be formed in other shapes and/or locations. For example, a label assembly 201 according to further embodiments of the present invention is shown in FIG. 8. The label assembly 201 includes a label 200 and a release liner 280 constructed in the same manner as the label 100 and the release liner 180 except as follows. The anchor portion 245 includes a top portion 245A that extends across the top side of the hanger 230. The release liner pieces 182 are omitted and an oval release liner piece 282 is provided beneath the top portion 245A and the pull tab 236A. The release liner piece 282 is formed in the same manner as the release liner pieces 282 and thereby serves to temporarily retain or support the hanger 230 as discussed above.

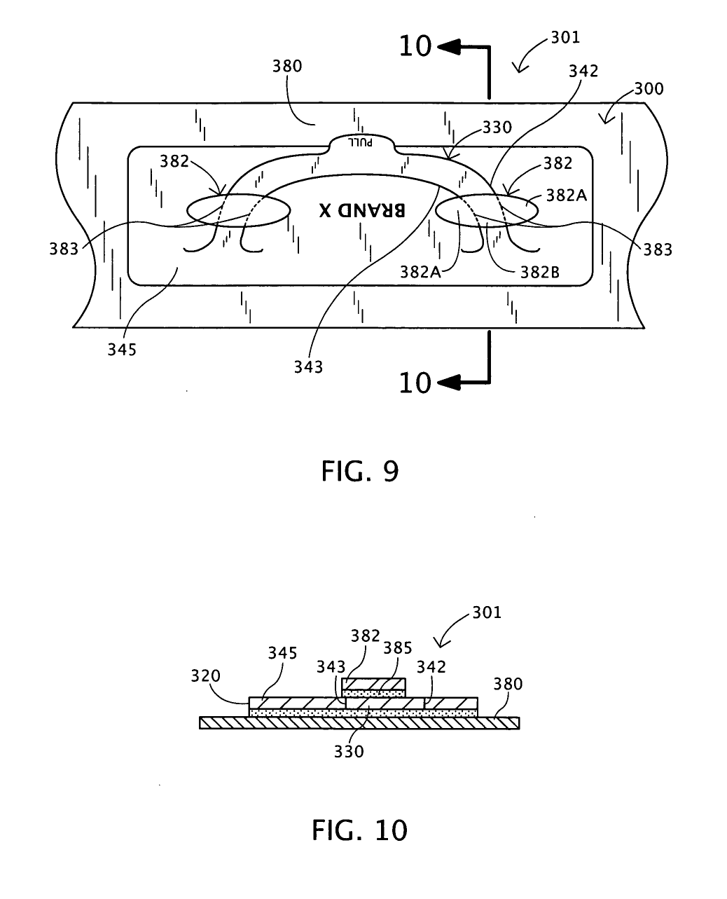

With reference to FIGS. 9 and 10, a label assembly 301 according to further embodiments of the present invention is shown therein. The label assembly 301 includes a label 300 and a release liner 380 constructed in the same manner as the label 100 and the release liner 180 except as follows. The hanger 330 is defined by cut lines 342, 343. The release liner pieces 182 are omitted and oval supplemental label pieces 382 are mounted on and adhered to the top surface of the base layer 320 by respective layers 385 of adhesive. The label pieces 382 may be self-adhesive face stock. According to some embodiments, the label pieces 382 are adhered only to the anchor portions 345 (i.e., active adhesive is only provided under the side portions 382A but not under the intermediate portion 382B so that the label piece 382 is not directly adhered to the hanger 330). Alternatively, the label pieces 382 may be adhered to both the anchor portions 345 and the hanger 330 (i.e., active adhesive is provided under both the side portions 382A and the intermediate portion 382B).

The label assembly 301 may be formed using any suitable method. According to some embodiments, the label pieces 382 are tamped or blown onto the base layer 320. The pieces 382 may be self-adhesive and/or the adhesive 385 may be applied to the underside of each piece 382 or to the top surface of the base layer 320 during assembly.

In use, the label pieces 382 may tear when the hanger 330 is lifted, and, optionally, score lines or perforations 383 may be provided in the label pieces 382 to facilitate tearing. Alternatively, the label pieces 382 may separate from the anchor portions 345 when the hanger 330 is lifted. In this case, the adhesive 385 may be a fugitive adhesive to prevent unintended exposure of active adhesive when the hanger 330 is deployed.

Each of the foregoing labels may be provided as “cut labels”, i.e., labels which are applied directly to articles without first being mounted on a release liner. The manufacture and application of such a label may be accomplished using a method as described in U.S. Pat. No. 6,361,010 to Grosskopf et al., the disclosure of which is hereby incorporated herein by reference in its entirety. The adhesive 110, for example, may be a non-pressure sensitive adhesive, preferably a heat activatable adhesive. Alternatively, the adhesive may be applied to the label (e.g., to the base layer 120) just prior to applying the label to the article, preferably by blowing the adhesive. The adhesive may be applied in a manner such as commonly referred to as “cut and stack” (a technique commonly used to apply cut labels to beer bottles, for example). The labels may also be pressure sensitive, in which case the labels are preferably diecut and stacked rather than being wound on a roll.

Each of the foregoing labels may be provided as in-mold labels using methods and constructions as described in U.S. Pat. No. 6,361,010 to Grosskopf et al. Suitable modifications to the described methods and apparatus as appropriate will be apparent to those of skill in the art upon reading the description herein.

According to some embodiments and as illustrated in FIG. 2, the label is, with the exception of the release liner pieces (e.g., the release liner pieces 182) a single-ply label (i.e., the base layer 120 consists of a single ply). Alternatively, the label may be a multi-ply label wherein the plurality of layers are bonded together to perform as a single layer or wherein the label plies are separable.

Any of the foregoing labels may include indicia as desired printed on the layer(s) from which the hanger is formed. Such indicia may include product identification, instructions, warnings, lot data, expiration data, and bar codes.

If desired, small patches of adhesive may be provided on the undersides of the hangers to temporarily secure them to the article or base layer. Such adhesive patches would preferably be provided under the corners of the hangers (e.g., the corners between the legs 134 and the pull tab 136A). The adhesive patches may be formed of a fugitive adhesive.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

What is claimed is:

1. A label assembly comprising:
a release liner; and
a label including:
a base layer releasably adhered to the release liner, the base layer including at least one label cut line formed therein defining a hanger and an adjacent anchoring portion; and
a release liner piece defined by at least one release liner cut line formed in the release liner;
wherein the release liner piece is adhered to the anchoring portion and underlies the hanger such that the release liner piece remains with the base layer and supports the hanger when the base layer is dispensed from the release liner.

2. The label assembly of claim 1 wherein the base layer is a single-ply base layer.

3. The label assembly of claim 1 wherein the release liner piece includes an intermediate portion and first and second extension portions extending from opposed sides of the intermediate portion, and wherein the intermediate portion underlies the hanger and the first and second extension portions underlie and are adhered to the anchoring portion on opposed sides of the hanger.

4. The label assembly of claim 3 wherein the intermediate portion is not directly adhered to the hanger.

5. The label assembly of claim 1 wherein the hanger includes at least two legs, each of the legs having an end connected to the anchoring portion such that, when the label is adhered to an article, the legs are foldable away from the article about the anchoring portion to form a continuous, closed loop.

6. The label assembly of claim 1 including indicia disposed on the label.

7. A label for use with an article, the label comprising:
a base layer including at least one label cut line formed therein defining a hanger and an adjacent anchoring portion;
a base adhesive layer coating a rear surface of the base layer; and
a release liner piece adhered to the anchoring portion by the base adhesive layer and underlying the hanger such that the release liner piece remains with the base layer and supports the hanger when the base layer is dispensed onto the article.

8. The label of claim 7 wherein the base layer is a single-ply base layer.

9. A label for use with an article, the label comprising:
a base layer including at least one label cut line formed therein defining a hanger and an adjacent anchoring portion;
a base adhesive layer coating a rear surface of the base layer;
a supplemental piece adhered to the anchoring portion by the base adhesive layer and overlying the hanger such that the supplemental piece retains the hanger with respect the anchor portion when the base layer is dispensed onto the article.

10. The label of claim 9 wherein the base layer is a single-ply base layer.

11. The label of claim 9 wherein the supplemental piece includes an intermediate portion and first and second extension portions extending from opposed sides of the intermediate portion, and wherein the intermediate portion underlies the hanger and the first and second extension portions underlie and are adhered to the anchoring portion on opposed sides of the hanger.

12. The label of claim 11 wherein the intermediate portion is not directly adhered to the hanger.

13. The label of claim 11 wherein the intermediate portion is adhered to the base layer by a fugitive adhesive.

14. The label of claim 11 wherein the supplemental piece is tearable to permit the hanger to be lifted away from the anchoring portion.

15. The label of claim 14 including perforations and/or a score line formed in the supplemental piece to facilitate tearing of the supplemental piece.

16. The label of claim 9 wherein the hanger includes at least two legs, each of the legs having an end connected to the anchoring portion such that, when the label is adhered to the article, the legs are foldable away from the article about the anchoring portion to form a continuous, closed loop.

17. The label of claim 9 including indicia disposed on the label.

18. A method for forming a label assembly, the method comprising:
providing a release liner;
releasably adhering a base layer to the release liner;
forming at least one label cut line in the base layer to define a hanger and an adjacent anchoring portion in the base layer; and
forming at least one release liner cut line in the release liner to define a release liner piece therein such that the release liner piece is adhered to the anchoring portion and underlies the hanger such that the release liner piece remains with the base layer and supports the hanger when the base layer is dispensed from the release liner.

19. The method of claim 18 wherein the base layer is a single ply base layer.

20. A method for dispensing a label onto an article, the method comprising:
providing a label assembly comprising:
a release liner;
a label including:
a base layer releasably adhered to the release liner, the base layer including at least one label cut line formed therein defining a hanger and an adjacent anchoring portion; and
a release liner piece defined by at least one release liner cut line formed in the release liner, wherein the release liner piece is adhered to the anchoring portion and underlies the hanger; and
dispensing the label from the release liner onto the article such that the release liner piece remains adhered to the anchoring portion and underlying the hanger to thereby support the hanger during the transition from the release liner to the article.
